(19) United States
(12) Patent Application Publication
(10) Pub. No.: US 2022/0100534 A1
(43) Pub. Date: Mar. 31, 2022

(54) REAL-TIME PREVIEW PERSONALIZATION

(71) Applicant: Snap Inc., Santa Monica, CA (US)

(72) Inventors: Roman Golobokov, London (GB); Sergei Vasilenko, London (GB)

(21) Appl. No.: 17/399,453

(22) Filed: Aug. 11, 2021

Related U.S. Application Data
(60) Provisional application No. 63/085,945, filed on Sep. 30, 2020.

(51) Int. Cl. G06F 9/451; G06F 9/445

(52) U.S. Cl. CPC G06F 9/451; G06F 9/4451

(57) ABSTRACT

A preview personalization system for generating and presenting previews of personalized media content at a client device, wherein the previews may be personalized, in real-time, based on one or more attributes which may include user profile data and contextual data accessed by the client device, according to certain example embodiments.

### CLAIM OF PRIORITY

This application claims the benefit of priority to U.S. Provisional Application Ser. No. 63/085,945, filed Sep. 30, 2020, which is incorporated herein by reference in its entirety.

### BACKGROUND

The incorporation of images of real people into digitized animation sequences or images is increasingly popular. Such systems may provide various graphical user interfaces (GUI) in which a user may capture or otherwise select an image, and orient at least a portion of the image within a media item in order to generate a personalized media item.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of example, and not limitation, in the figures of the accompanying drawings in which:

FIG. 1 is a diagrammatic representation of a networked environment in which the present disclosure may be deployed, in accordance with some examples.

FIG. 2 is a diagrammatic representation of a messaging system, in accordance with some examples, that has both client-side and server-side functionality.

FIG. 3 is a flowchart depicting a method 300 for generating and causing display of a preview of a personalized media item, in accordance with one embodiment.

FIG. 4 is a flowchart depicting a method 400 for generating a preview of a personalized media item, in accordance with one embodiment.

FIG. 5 is a flowchart depicting a method 500 for generating a preview of a personalized media item, in accordance with one embodiment.

FIG. 6 is a flowchart depicting a method 600 for generating a preview of a personalized media item, in accordance with one embodiment.

FIG. 7 is a flowchart depicting a method 700 for generating a preview of a personalized media item, in accordance with one embodiment.

FIG. 8 is an interface diagram depicting a GUI presented by a preview personalization system, in accordance with one embodiment.

FIG. 9 is an interface diagram depicting a GUI presented by a preview personalization system, in accordance with one embodiment.

FIG. 10 is an interface diagram depicting a GUI presented by a preview personalization system, in accordance with one embodiment.

FIG. 11 is a diagrammatic representation of a machine in the form of a computer system within which a set of instructions may be executed for causing the machine to perform any one or more of the methodologies discussed herein, in accordance with some examples.

FIG. 12 is a block diagram showing a software architecture within which examples may be implemented.

FIG. 13 is a diagrammatic representation of a processing environment, in accordance with some examples.

### DETAILED DESCRIPTION

The disclosed system provides users with a means for generating and presenting previews of media content at a client device, wherein the previews may be personalized, in real-time, based on one or more attributes which may include user profile data accessed by the client device, according to certain example embodiments. For example, a preview personalization system may cause display of a graphical user interface (GUI) at a client device, wherein the GUI includes a display of image or video data which may be captured or otherwise generated by a camera associated with the client device (i.e., a camera integrated into the client device, or which may be communicatively coupled with the client device). The preview personalization system may access a collection of media content at the client device, wherein the collection of media content includes one or more media items which comprise graphical elements, and in some instances, template features which may be updated or modified based on features which may be retrieved from a user profile, or based on certain contextual conditions that include location data and temporal data. Responsive to accessing the collection of media content, the preview personalization system may generate a preview of media content from among the collection of media content based on the user profile data. For example, the user profile data may include a set of user preferences, or image data which may be associated with the user profile. The preview of the media content may be displayed at a position within the GUI at the client device. Accordingly, the user of the client device may selectively scroll through the collection of media content, and in response, the preview personalization system may generate and display previews of the media content from among the collection of media content based on the user profile data in real-time.

In certain example embodiments, the user profile data may include image data as well as user preference data. For example, the image data may include an image captured by a user of the client device, such as a selfie, that comprises a set of facial features and landmarks. According to certain embodiments, a user of the client device may capture an image to be associated with the user profile, wherein the image is to be used by the preview personalization system for the purposes of personalizing media content. In some embodiments, the user profile data may include user preference data, wherein the user preference data comprises a set of user selections to be accessed by the preview personalization system to personalize media content.

In some embodiments, responsive to presenting the GUI at the client device, the preview personalization system may display a request within the GUI, wherein the request includes a request for the user to confirm personalization of the media content. Responsive to receiving a selection of the request (i.e., an acceptance or approval), the preview personalization system may access the user profile data associated with the client device in order to access user preferences or images to be used in the personalization of the media content. In certain embodiments, responsive to receiving a selection of the request, the preview personalization system may activate a camera associated with the client device, and cause the camera to capture an image to be allocated to the user profile data for use in personalization of media content.

In some embodiments, the user profile data may include an opt-in by the user to one or more features of the preview personalization system. For example, in certain embodiments, features related to the personalization of media content based on user profile data may only be performed subsequent to determining that the user has provided an opt-in to the feature based on one or more selections within the user profile data.

In some embodiments, the preview personalization system may personalize preview of media content based on user profile data from a plurality of user profiles. For example, in some embodiments, a user of a client device (i.e., a first user) may provide a request to generate a message, wherein the request to generate the message includes an identification of one or more recipients, such as a second user. Responsive to receiving the request to generate the message to the second user, the preview personalization system may access user profile data associated with the first user and the second user in order to personalize media content.

In certain embodiments, the preview personalization system may filter or otherwise curate a collection of media content for display at the users client device based on one or more factors that include user profile data, as well as contextual data. Responsive to accessing the collection of media content, the preview personalization system may filter the collection of media content based on filter criteria that includes user profile data, as well as contextual factors.

Consider an illustrative example from a user perspective. A user (i.e., a first user) of the preview personalization system may engage in a communication session with a second user, wherein the first user and second user have corresponding user profile data that include images. The first user may provide an input to access a media repository that comprises a collection of media content. Responsive to receiving the request to access the media repository, the personalized preview system accesses user profile data associated with the first user, wherein the user profile data includes an image that depicts a face (i.e., a face of the user), wherein the depiction of the face comprises a set of facial landmarks. The personalized preview system generates one or more previews of personalized media content from among the collection of media content based on the user profile data, and causes display of a presentation of the previews within a GUI. In some embodiments, the one or more previews may be based on user profile data from the first user and user profile data from the second user.

Networked Computing Environment

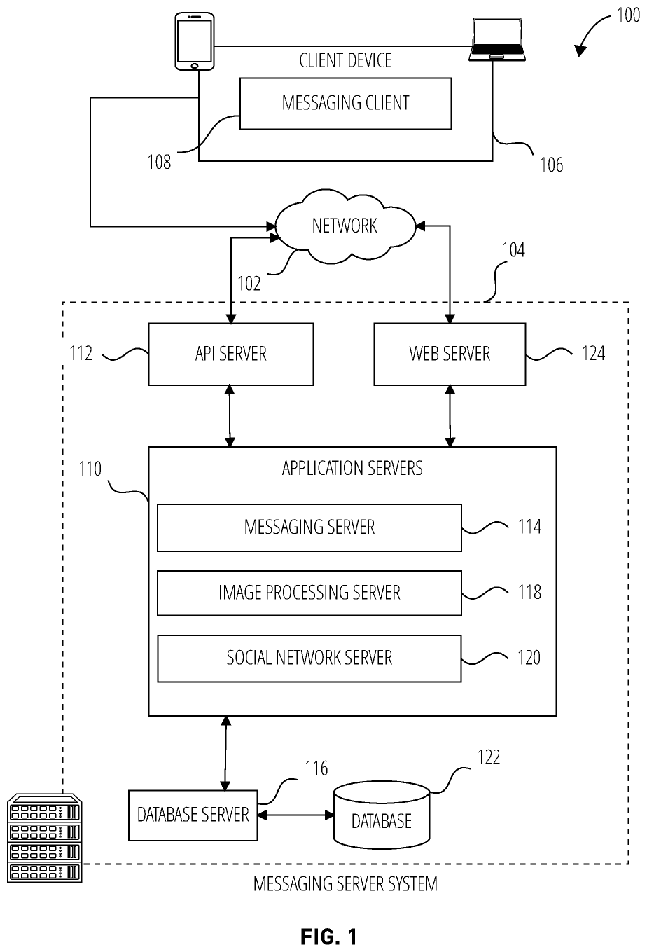

FIG. 1 is a block diagram showing an example messaging system 100 for exchanging data (e.g., messages and associated content) over a network. The messaging system 100 includes multiple instances of a client device 106, each of which hosts a number of applications, including a messaging client 108. Each messaging client 108 is communicatively coupled to other instances of the messaging client 108 and a messaging server system 104 via a network 102 (e.g., the Internet).

A messaging client 108 is able to communicate and exchange data with another messaging client 108 and with the messaging server system 104 via the network 102. The data exchanged between messaging client 108, and between a messaging client 108 and the messaging server system 104, includes functions (e.g., commands to invoke functions) as well as payload data (e.g., text, audio, video or other multimedia data).

The messaging server system 104 provides server-side functionality via the network 102 to a particular messaging client 108. While certain functions of the messaging system 100 are described herein as being performed by either a messaging client 108 or by the messaging server system 104, the location of certain functionality either within the messaging client 108 or the messaging server system 104 may be a design choice. For example, it may be technically preferable to initially deploy certain technology and functionality within the messaging server system 104 but to later migrate this technology and functionality to the messaging client 108 where a client device 106 has sufficient processing capacity.

The messaging server system 104 supports various services and operations that are provided to the messaging client 108. Such operations include transmitting data to, receiving data from, and processing data generated by the messaging client 108. This data may include message content, client device information, geolocation information, media augmentation and overlays, message content persistence conditions, social network information, and live event information, as examples. Data exchanges within the messaging system 100 are invoked and controlled through functions available via user interfaces (UIs) of the messaging client 108.

Turning now specifically to the messaging server system 104, an Application Program Interface (API) server 112 is coupled to, and provides a programmatic interface to, application servers 110. The application servers 110 are communicatively coupled to a database server 116, which facilitates access to a database 122 that stores data associated with messages processed by the application servers 110. Similarly, a web server 124 is coupled to the application servers 110, and provides web-based interfaces to the application servers 110. To this end, the web server 124 processes incoming network requests over the Hypertext Transfer Protocol (HTTP) and several other related protocols.

The Application Program Interface (API) server 112 receives and transmits message data (e.g., commands and message payloads) between the client device 106 and the application servers 110. Specifically, the Application Program Interface (API) server 112 provides a set of interfaces (e.g., routines and protocols) that can be called or queried by the messaging client 108 in order to invoke functionality of the application servers 110. The Application Program Interface (API) server 112 exposes various functions supported by the application servers 110, including account registration, login functionality, the sending of messages, via the application servers 110, from a particular messaging client 108 to another messaging client 108, the sending of media files (e.g., images or video) from a messaging client 108 to a messaging server 114, and for possible access by another messaging client 108, the settings of a collection of media data (e.g., story), the retrieval of a list of friends of a user of a client device 106, the retrieval of such collections, the retrieval of messages and content, the addition and deletion of entities (e.g., friends) to an entity graph (e.g., a social graph), the location of friends within a social graph, and opening an application event (e.g., relating to the messaging client 108).

The application servers 110 host a number of server applications and subsystems, including for example a messaging server 114, an image processing server 118, and a social network server 120. The messaging server 114 implements a number of message processing technologies and functions, particularly related to the aggregation and other processing of content (e.g., textual and multimedia content) included in messages received from multiple instances of the messaging client 108. As will be described in further detail, the text and media content from multiple sources may be aggregated into collections of content (e.g., called stories or galleries). These collections are then made available to the messaging client 108. Other processor and memory intensive processing of data may also be performed server-side by the messaging server 114, in view of the hardware requirements for such processing.

The application servers 110 also include an image processing server 118 that is dedicated to performing various image processing operations, typically with respect to images or video within the payload of a message sent from or received at the messaging server 114.

The social network server 120 supports various social networking functions and services and makes these functions and services available to the messaging server 114. Examples of functions and services supported by the social network server 120 include the identification of other users of the messaging system 100 with which a particular user has relationships or is “following,” and also the identification of other entities and interests of a particular user.

System Architecture

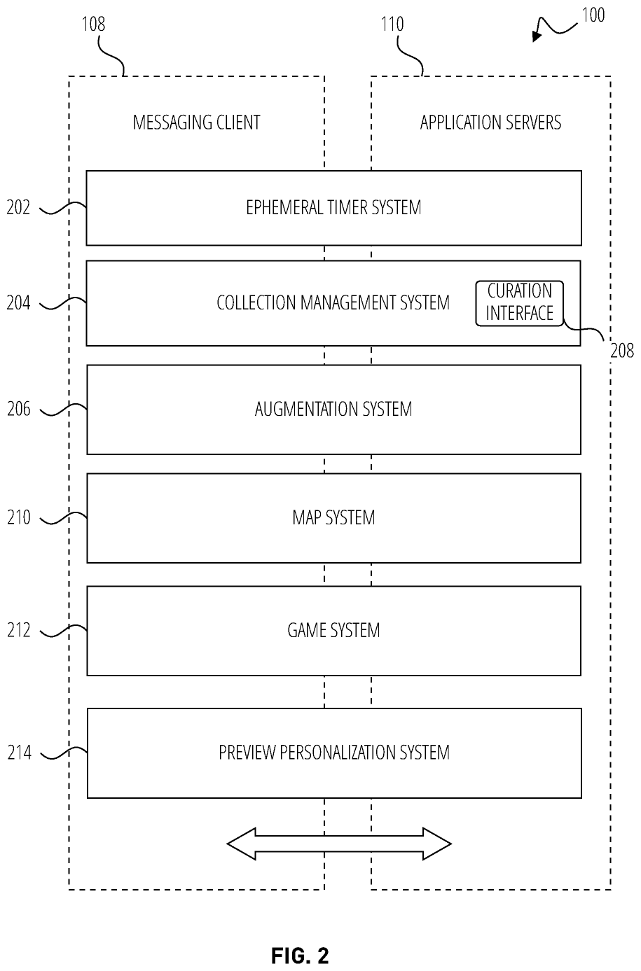

FIG. 2 is a block diagram illustrating further details regarding the messaging system 100, according to some examples. Specifically, the messaging system 100 is shown to comprise the messaging client 108 and the application servers 110. The messaging system 100 embodies a number of subsystems, which are supported on the client-side by the messaging client 108 and on the sever-side by the application servers 110. These subsystems include, for example, an ephemeral timer system 202, a collection management system 204, an augmentation system 206, a map system 210, a game system 212, and a preview personalization system 214.

The ephemeral timer system 202 is responsible for enforcing the temporary or time-limited access to content by the messaging client 108 and the messaging server 114. The ephemeral timer system 202 incorporates a number of timers that, based on duration and display parameters associated with a message, or collection of messages (e.g., a story), selectively enable access (e.g., for presentation and display) to messages and associated content via the messaging client 108. Further details regarding the operation of the ephemeral timer system 202 are provided below.

The collection management system 204 is responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the messaging client 108.

The collection management system 204 furthermore includes a curation interface 208 that allows a collection manager to manage and curate a particular collection of content. For example, the curation interface 208 enables an event organizer to curate a collection of content relating to a specific event (e.g., delete inappropriate content or redundant messages). Additionally, the collection management system 204 employs machine vision (or image recognition technology) and content rules to automatically curate a content collection. In certain examples, compensation may be paid to a user for the inclusion of user-generated content into a collection. In such cases, the collection management system 204 operates to automatically make payments to such users for the use of their content.

The augmentation system 206 provides various functions that enable a user to augment (e.g., annotate or otherwise modify or edit) media content associated with a message. For example, the augmentation system 206 provides functions related to the generation and publishing of media overlays for messages processed by the messaging system 100. The augmentation system 206 operatively supplies a media overlay or augmentation (e.g., an image filter) to the messaging client 108 based on a geolocation of the client device 106. In another example, the augmentation system 206 operatively supplies a media overlay to the messaging client 108 based on other information, such as social network information of the user of the client device 106. A media overlay may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo) at the client device 106. For example, the media overlay may include text or image that can be overlaid on top of a photograph taken by the client device 106. In another example, the media overlay includes an identification of a location overlay (e.g., Venice beach), a name of a live event, or a name of a merchant overlay (e.g., Beach Coffee House). In another example, the augmentation system 206 uses the geolocation of the client device 106 to identify a media overlay that includes the name of a merchant at the geolocation of the client device 106. The media overlay may include other indicia associated with the merchant. The media overlays may be stored in the database 122 and accessed through the database server 116.

In some examples, the augmentation system 206 provides a user-based publication platform that enables users to select a geolocation on a map and upload content associated with the selected geolocation. The user may also specify circumstances under which a particular media overlay should be offered to other users. The augmentation system 206 generates a media overlay that includes the uploaded content and associates the uploaded content with the selected geolocation.

In other examples, the augmentation system 206 provides a merchant-based publication platform that enables merchants to select a particular media overlay associated with a geolocation via a bidding process. For example, the augmentation system 206 associates the media overlay of the highest bidding merchant with a corresponding geolocation for a predefined amount of time.

The map system 210 provides various geographic location functions, and supports the presentation of map-based media content and messages by the messaging client 108. For example, the map system 210 enables the display of user icons or avatars on a map to indicate a current or past location of “friends” of a user, as well as media content (e.g., collections of messages including photographs and videos) generated by such friends, within the context of a map. For example, a message posted by a user to the messaging system 100 from a specific geographic location may be displayed within the context of a map at that particular location to “friends” of a specific user on a map interface of the messaging client 108. A user can furthermore share his or her location and status information (e.g., using an appropriate status avatar) with other users of the messaging system 100 via the messaging client 108, with this location and status information being similarly displayed within the context of a map interface of the messaging client 108 to selected users.

The game system 212 provides various gaming functions within the context of the messaging client 108. The messaging client 108 provides a game interface providing a list of available games that can be launched by a user within the context of the messaging client 108, and played with other users of the messaging system 100. The messaging system 100 further enables a particular user to invite other users to participate in the play of a specific game, by issuing invitations to such other users from the messaging client 108. The messaging client 108 also supports both the voice and text messaging (e.g., chats) within the context of gameplay, provides a leaderboard for the games, and also supports the provision of in-game rewards (e.g., coins and items).

The preview personalization system 214 provides functions related to generating and causing display of personalized previews of media items based on user profile data and one or more media templates, according to certain example embodiments.

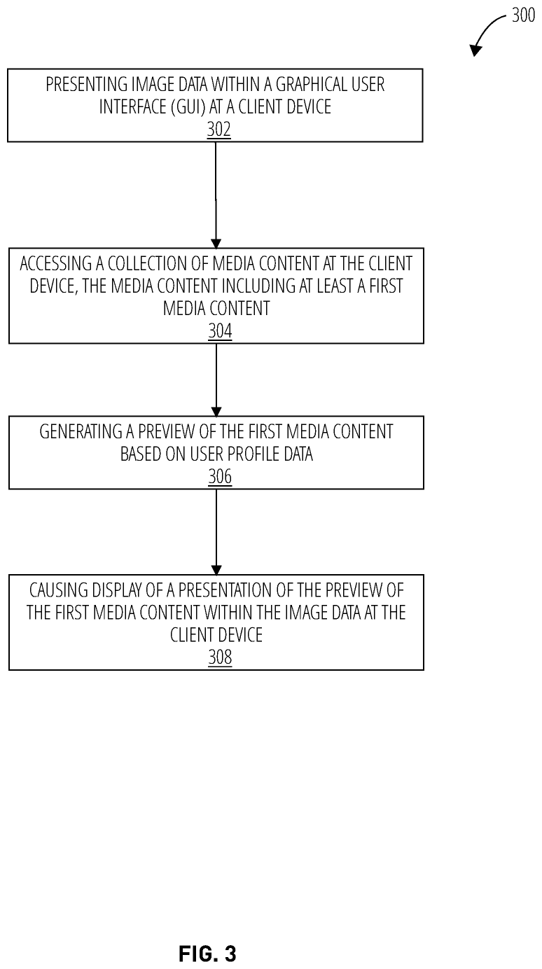

FIG. 3 is a flowchart illustrating operations of a preview personalization system 214 in performing a method 300 for generating and causing display of a preview of a personalized media item, according to certain example embodiments. Operations of the method 300 may be performed by one or more subsystems of the messaging system 100 described above with respect to FIG. 2, such as the preview personalization system 214. As shown in FIG. 3, the method 300 includes one or more operations, 302, 304, 306, and 308.

At operation 302, the preview personalization system 214 presents a GUI at a client device 106, wherein the GUI includes a display of image data. For example, the image data may be generated by a camera associated with the client device 106, or accessed from a repository by the client device 106. For example, a user of the client device 106 may provide a request to retrieve the image data from a database.

At operation 304, the preview personalization system 214 accesses a collection of media content in response to the display of the GUI at the client device 106, wherein the collection of media content includes at least a first media content. For example, the collection of media content may comprise media content such as media filters, graphical content, images, videos, as well as audio data.

At operation 306, the preview personalization system 214 generates a preview of the first media content from among the collection of media content based on at lease the user profile data associated with a user of the client device 106. For example the user profile data may include user preferences as well as images.

In some embodiments, the first media content may for example comprise a set of graphical elements, wherein at least a portion of the set of graphical elements may be personalized or otherwise configured based on the user profile data. As an illustrative example, the first media content may include a customizable region, wherein an image associated with a user profile may be displayed within the customizable region in order to personalize the first media content.

At operation 308, the preview of the first media content is displayed at a position within the image data at the client device 106. In some embodiments, a user of the client device may provide an input to define the position of the preview of the first media content (i.e., a user input that selects the position). In further embodiments, the first media content may comprise corresponding display features which define the position in which the preview of the first media content is to be displayed.

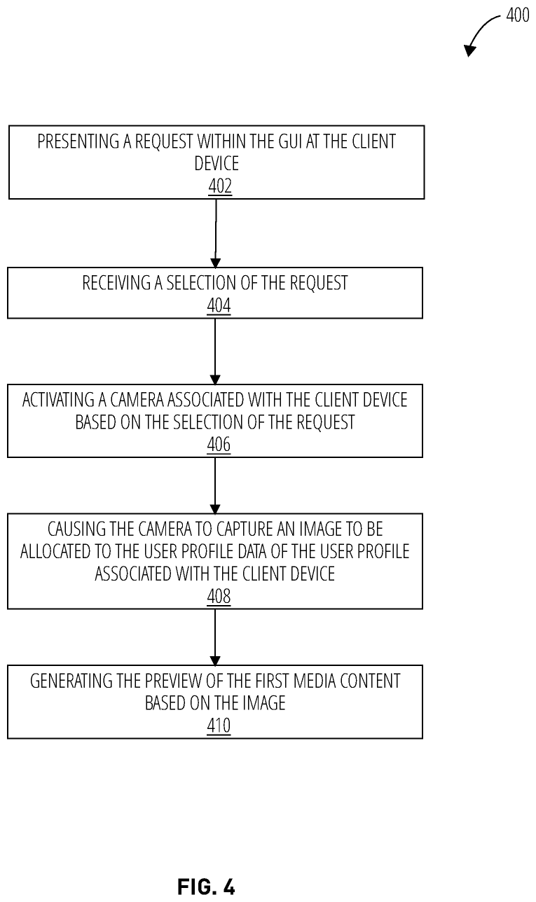

FIG. 4 is a flowchart illustrating operations of a preview personalization system 214 in performing a method 400 for generating a preview of a personalized media item, according to certain example embodiments. Operations of the method 400 may be performed by one or more subsystems of the messaging system 100 described above with respect to FIG. 2, such as the preview personalization system 214. As shown in FIG. 4, the method 400 includes one or more operations 402, 404, 406, 408 and 410 which may be performed as a subroutine of the method 300.

At operation 402, the preview personalization system 214 presents a request within the GUI at the client device 106. For example, the preview personalization system 214 may present the request responsive to the display of the GUI at the client device 106. At operation 404, the preview personalization system 214 receives a selection of the request form the client device 106.

Responsive to receiving the selection of the request from the client device 106, the preview personalization system 214 activates a camera associated with the client device 106. For example, the request may include a request to confirm activation of a media personalization feature of the preview personalization system 214, and responsive to an acceptance of the request, the preview personalization system 214 may activate the camera associated with the client device 106.

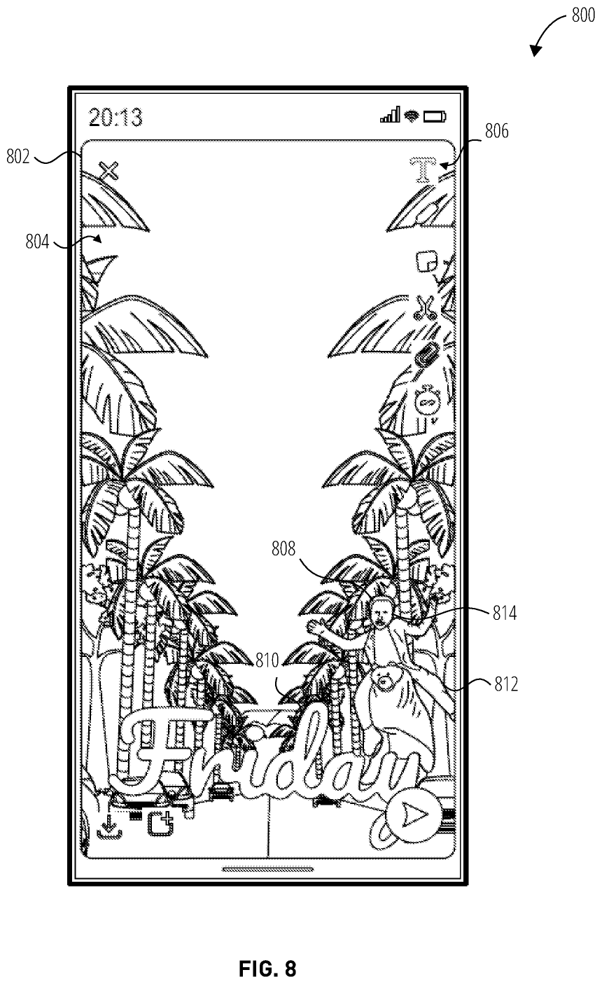

At operation 408, the preview personalization system 214 causes the camera associated with the client device 106 to capture an image to be allocated to a user profile associated with the client device 106, based on the selection of the request. At operation 410, the preview personalization system 214 personalizes media content from among the collection of media content based on the image associated with the user profile. Accordingly, the preview of the media item generated based on the user profile data may be presented among a collection of media items, as seen in the interface interface flow diagram 800 (deleted) 00 depicted in FIG. 8 (deleted).

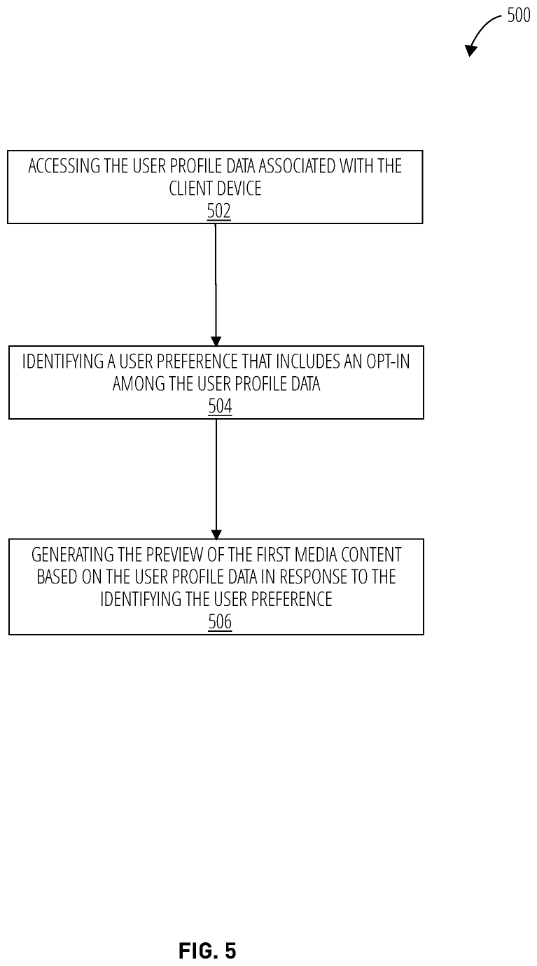

FIG. 5 is a flowchart illustrating operations of a preview personalization system 214 in performing a method 500 for generating a preview of personalized media content, according to certain example embodiments. Operations of the method 500 may be performed by one or more subsystems of the messaging system 100 described above with respect to FIG. 2, such as the preview personalization system 214. As shown in FIG. 5, the method 500 includes one or more operations 502, 504, and 506 that may be performed as a subroutine of the method 300.

At operation 502, the preview personalization system 214 accesses user profile data responsive to causing display of the GUI. For example, the user profile data may include user profile data associated with a user of the client device 106, as well as user profile data associated with a recipient of a message being generated by a user of the client device 106.

At operation 504, the preview personalization system 214 identifies user preferences among the user profile data, wherein the user preferences include an opt-in to one or more features of the preview personalization system 214.

At operation 506, responsive to identifying the opt-in among the user profile data, the preview personalization system 214 generates a preview of media content from among a collection of media content.

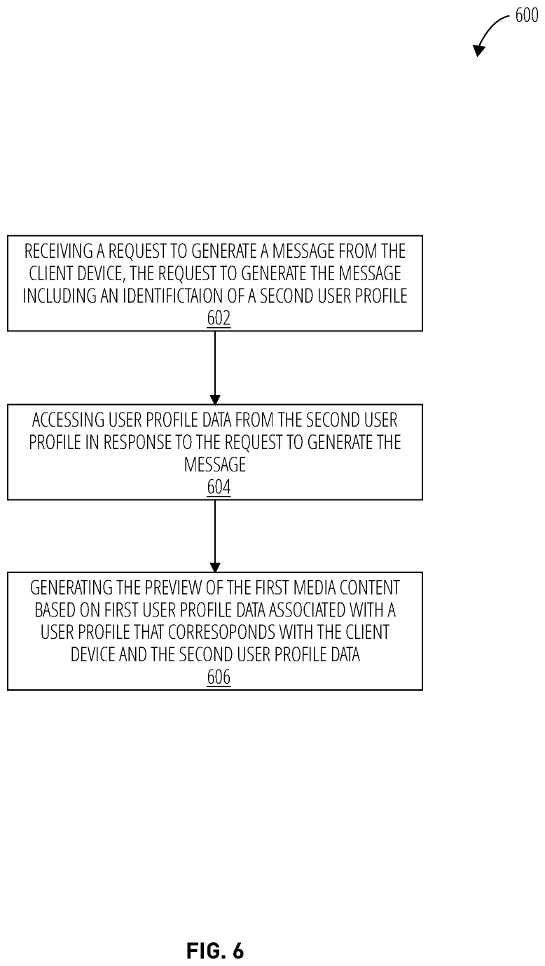

FIG. 6 is a flowchart illustrating operations of a preview personalization system 214 in performing a method 600 for generating a preview of a personalized media item, according to certain example embodiments. Operations of the method 600 may be performed by one or more subsystems of the messaging system 100 described above with respect to FIG. 2, such as the preview personalization system 214. As shown in FIG. 6, the method 600 includes one or more operations 602, 604, and 606, which may be performed as a precursor to the method 300.

At operation 602, the preview personalization system 214 receives a request to generate a message from the client device 106, wherein the request to generate the message includes an identification of a user profile. For example, a user of the client device 106 (i.e., a first user) may provide an input to generate a message to a second user.

At operation 604, the preview personalization system 214 accesses user profile data associated with the first user profile and user profile data associated with the second user profile in response to the request to generate the message, wherein the user profile data includes user preferences as well as one or more images.

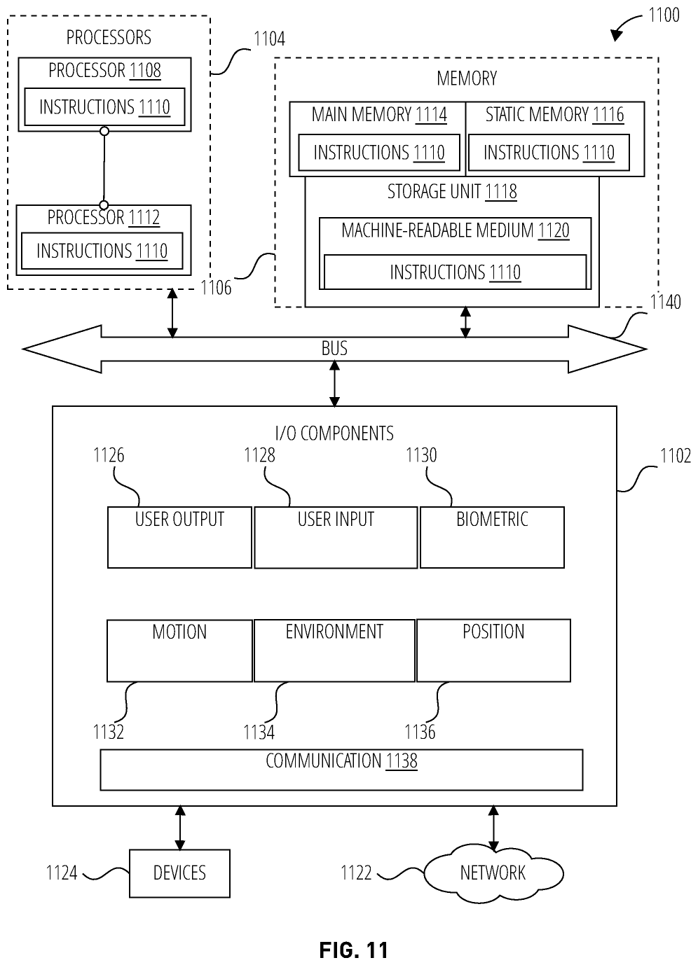

At operation 606, the preview personalization system 214 generates a preview of media content based on the first user profile data and the second user profile data. For example, consider the preview 1102 depicted in the diagram 1100 of FIG. 11 (deleted).

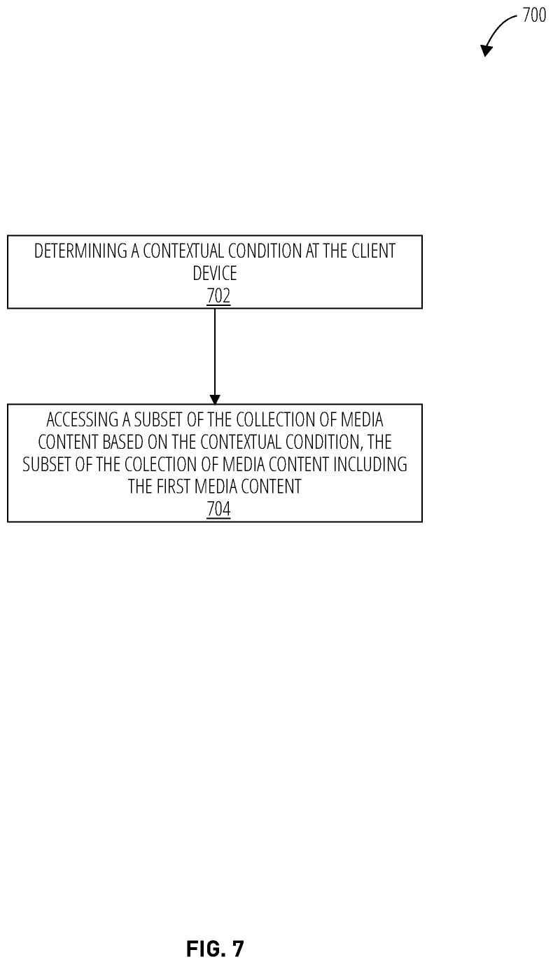

FIG. 7 is a flowchart illustrating operations of a preview personalization system 214 in performing a method 700 for generating a preview of a personalized media item, according to certain example embodiments. Operations of the method 700 may be performed by one or more subsystems of the messaging system 100 described above with respect to FIG. 2, such as the preview personalization system 214. As shown in FIG. 7, the method 700 includes one or more operations 702, and 704, which may be performed as a precursor to the method 300.

At operation 702, the preview personalization system 214 determines a contextual condition at the client device 106. The contextual condition may include location data, temporal data, as well as user interaction data. For example, in some embodiments, the preview personalization system 214 may determine the contextual condition responsive to receiving a request to generate a GUI at the client device 106, as discussed in operation 302 of the method 300.

At operation 704, the preview personalization system 214 accesses a subset of the collection of media content based on the contextual condition. For example, the subset of the collection of media content may comprise a portion of the collection of media content that remains subsequent to filtering the collection of media content based on filter criteria that include the contextual condition.

FIG. 8 is an interface diagram 800 depicting a GUI 802 presented by a preview personalization system 214, in accordance with one embodiment. As seen in the interface diagram 800, the GUI 802 may include a display of image or video content 804, as well as a set of menu elements 806.

As discussed in embodiments described in the method 300 of FIG. 3, a preview 808 of media content may be displayed at a position within the GUI 802 of a client device 106, wherein the preview 808 may be generated on media content from among a collection of media content, and user profile data associated with a user of the client device 106.

In some embodiments, a user may provide an input to modify a display of the preview 808 within the GUI 802. For example, the input may selectively place the preview 808 at a position within the GUI 802, or in some embodiments, may change or modify a size, alignment, or orientation of the preview 808.

In some embodiments, attributes of the preview 808 may be defined by contextual conditions that include location data and temporal data. For example, as seen in the interface diagram 800, the preview 808 comprises a set of graphical elements that include stylized text string 810. The stylized text string 810 is depicted in FIG. 8 as “FRIDAY,” however the text may be modified by the preview personalization system 214 based on current temporal data, as well as current location data.

In some embodiments, a user of the preview personalization system 214 may provide an input to scroll through media content from among the collection of media content in order to generate an update of the preview 808. For example, the input may include a swiping input, or simply a touch or tap input. The update may for example be based on graphical elements that correspond with media content from among the collection of media content accessed by the preview personalization system 214.

In some embodiments, the media content in which the preview 808 is generated may comprise a media template that includes a set of graphical elements 812, wherein the user profile data 814 may be incorporated into the graphical elements 812 to generate the preview 808. For example, as seen in FIG. 8, the user profile data 814 may include an image, such as a selfie. Accordingly, the graphical elements 812 associated with the media content may include a region to display or otherwise present the user profile data 814.

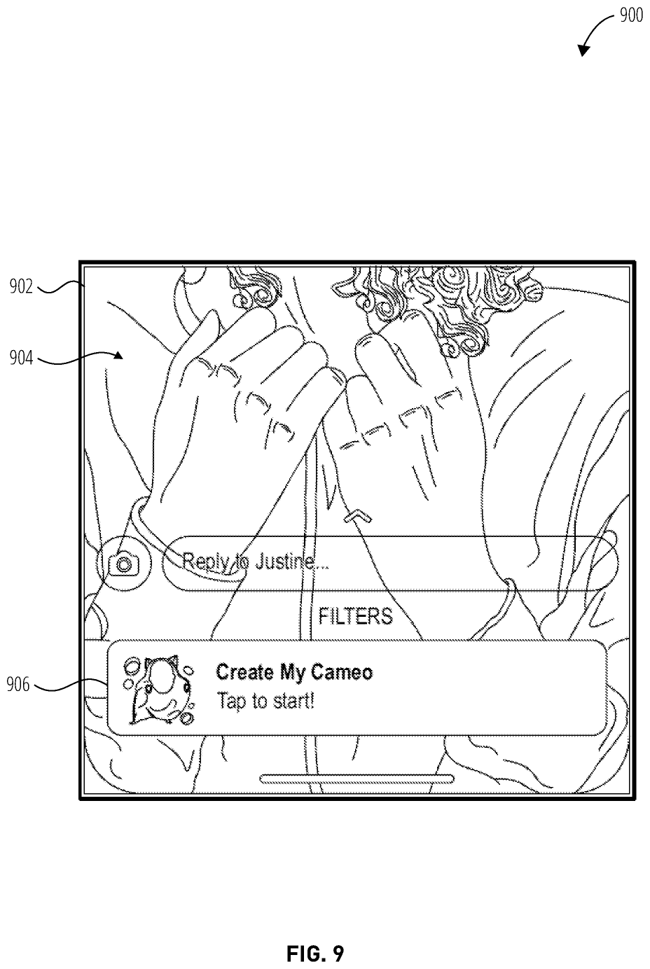

FIG. 9 is an interface diagram 90000 depicting a GUI 902 presented by a preview personalization system 214, in accordance with one embodiment. As seen in the interface diagram 90000, the GUI 902 may include a display of message content 904, wherein the message content 904 may include image or video data.

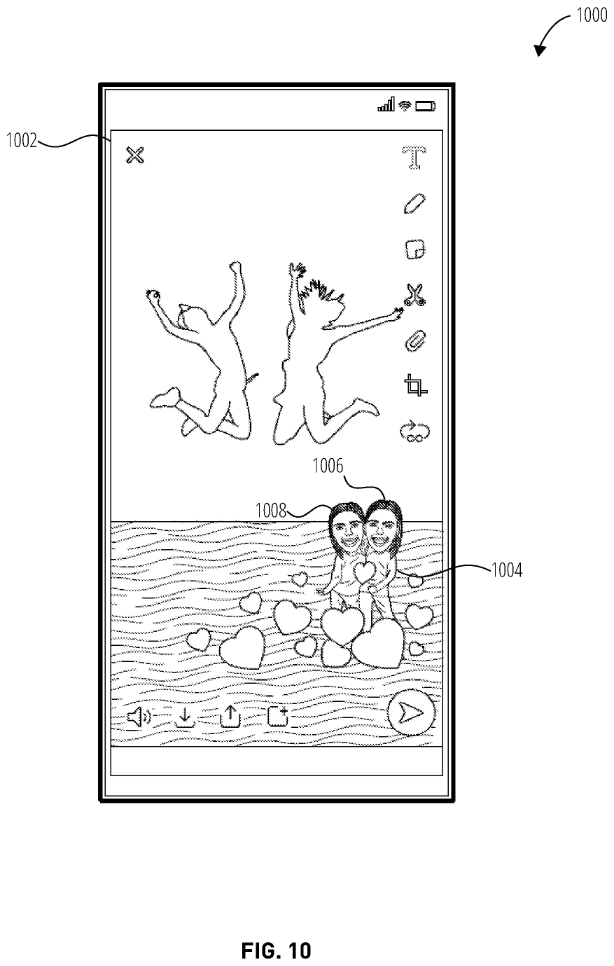

As discussed in the method 400 depicted in FIG. 4, in certain embodiments a request, such as the request 906 may be presented within the GUI 902. For example, the request 906 may be presented within the GUI 902 responsive to receiving a message that comprises the message content 904. The request 906 may include a request to generate a response to the message, wherein the response to the message includes personalized media content, such as the personalized media content 1004 depicted in the interface diagram 1000 of FIG. 10.

In some embodiments, a user of the client device 106 may provide an input to select the request 906 in order to cause display of the GUI 802 depicted in the interface diagram 800 of FIG. 8, or the GUI 1002 in the interface diagram 1000 of FIG. 10. In such embodiments, the preview personalization system 214 may access a collection of media content that comprises a set of media content in order to generate and cause display of personalized previews of the media content within the GUI.

In some embodiments, the collection of media content accessed by the preview personalization system 214 may be filtered based on one or more of user attributes, user profile data, and contextual data. For example, the collection of media content may be filtered based on user profile data of a first user associated with the client device 106, as well as user profile data associated with a second user associated with the message that comprises the message content 904 (i.e., a sender of the message).

FIG. 10 is an interface diagram 1000 depicting a GUI 1002 presented by a preview personalization system 214, in accordance with one embodiment. As seen in the interface diagram 1000, the GUI 100202 may include a display of a preview of personalized media content 1004, wherein the personalized media content 1004 may be personalized based on user profile data from a plurality of user accounts, such as the user profile data 1006 and the user profile data 1008.

In some example embodiments, the preview personalization system 214 may access a collection of media content and select media content that may be personalized based on user profile data from a plurality of user profiles.

In some embodiments, the media content may be identified or otherwise selected based on contextual data as well, wherein the contextual data includes message data, temporal data, location data, and user profile data that indicates a relationship between one or more users.

Accordingly, the preview personalization system 214 may generate and cause display of a preview of personalized media content 1004 at a position within the GUI 1002.

Machine Architecture

FIG. 11 is a diagrammatic representation of the machine 1100 within which instructions 1110 (e.g., software, a program, an application, an applet, an app, or other executable code) for causing the machine 1100 to perform any one or more of the methodologies discussed herein may be executed. For example, the instructions 1110 may cause the machine 1100 to execute any one or more of the methods described herein. The instructions 1110 transform the general, non-programmed machine 1100 into a particular machine 1100 programmed to carry out the described and illustrated functions in the manner described. The machine 1100 may operate as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1110, sequentially or otherwise, that specify actions to be taken by the machine 1100. Further, while only a single machine 1100 is illustrated, the term “machine” shall also be taken to include a collection of machines that individually or jointly execute the instructions 1110 to perform any one or more of the methodologies discussed herein. The machine 1100, for example, may comprise the client device 106 or any one of a number of server devices forming part of the messaging server system 104. In some examples, the machine 1100 may also comprise both client and server systems, with certain operations of a particular method or algorithm being performed on the server-side and with certain operations of the particular method or algorithm being performed on the client-side.

The machine 1100 may include processors 1104, memory 1106, and input/output I/O components 638, which may be configured to communicate with each other via a bus 1140. In an example, the processors 1104 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1108 and a processor 1112 that execute the instructions 1110. The term “processor” is intended to include multi-core processors that may comprise two or more independent processors (sometimes referred to as “cores”) that may execute instructions contemporaneously. Although FIG. 11 shows multiple processors 1104, the machine 1100 may include a single processor with a single-core, a single processor with multiple cores (e.g., a multi-core processor), multiple processors with a single core, multiple processors with multiples cores, or any combination thereof.

The memory 1106 includes a main memory 1114, a static memory 1116, and a storage unit 1118, both accessible to the processors 1104 via the bus 1140. The main memory 1106, the static memory 1116, and storage unit 1118 store the instructions 1110 embodying any one or more of the methodologies or functions described herein. The instructions 1110 may also reside, completely or partially, within the main memory 1114, within the static memory 1116, within machine-readable medium 1120 within the storage unit 1118, within at least one of the processors 1104 (e.g., within the Processor's cache memory), or any suitable combination thereof, during execution thereof by the machine 1100.

The I/O components 1102 may include a wide variety of components to receive input, provide output, produce output, transmit information, exchange information, capture measurements, and so on. The specific I/O components 1102 that are included in a particular machine will depend on the type of machine. For example, portable machines such as mobile phones may include a touch input device or other such input mechanisms, while a headless server machine will likely not include such a touch input device. It will be appreciated that the I/O components 1102 may include many other components that are not shown in FIG. 11. In various examples, the I/O components 1102 may include user output components 1126 and user input components 1128. The user output components 1126 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1128 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1102 may include biometric components 1130, motion components 1132, environmental components 1134, or position components 1136, among a wide array of other components. For example, the biometric components 1130 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1132 include acceleration sensor components (e.g., accelerometer), gravitation sensor components, rotation sensor components (e.g., gyroscope).

The environmental components 1134 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the client device 106 may have a camera system comprising, for example, front cameras on a front surface of the client device 106 and rear cameras on a rear surface of the client device 106. The front cameras may, for example, be used to capture still images and video of a user of the client device 106 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the client device 106 may also include a 360° camera for capturing 360° photographs and videos.

Further, the camera system of a client device 106 may include dual rear cameras (e.g., a primary camera as well as a depth-sensing camera), or even triple, quad or penta rear camera configurations on the front and rear sides of the client device 106. These multiple cameras systems may include a wide camera, an ultra-wide camera, a telephoto camera, a macro camera and a depth sensor, for example.

The position components 1136 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1102 further include communication components 1138 operable to couple the machine 1100 to a network 1122 or devices 1124 via respective coupling or connections. For example, the communication components 1138 may include a network interface Component or another suitable device to interface with the network 1122. In further examples, the communication components 1138 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1124 may be another machine or any of a wide variety of peripheral devices (e.g., a peripheral device coupled via a USB).

Moreover, the communication components 1138 may detect identifiers or include components operable to detect identifiers. For example, the communication components 1138 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1138, such as location via Internet Protocol (IP) geolocation, location via Wi-Fi® signal triangulation, location via detecting an NFC beacon signal that may indicate a particular location, and so forth.

The various memories (e.g., main memory 1114, static memory 1116, and memory of the processors 1104) and storage unit 1118 may store one or more sets of instructions and data structures (e.g., software) embodying or used by any one or more of the methodologies or functions described herein. These instructions (e.g., the instructions 1110), when executed by processors 1104, cause various operations to implement the disclosed examples.

The instructions 1110 may be transmitted or received over the network 1122, using a transmission medium, via a network interface device (e.g., a network interface component included in the communication components 1138) and using any one of several well-known transfer protocols (e.g., hypertext transfer protocol (HTTP)). Similarly, the instructions 1110 may be transmitted or received using a transmission medium via a coupling (e.g., a peer-to-peer coupling) to the devices 1124.

Software Architecture

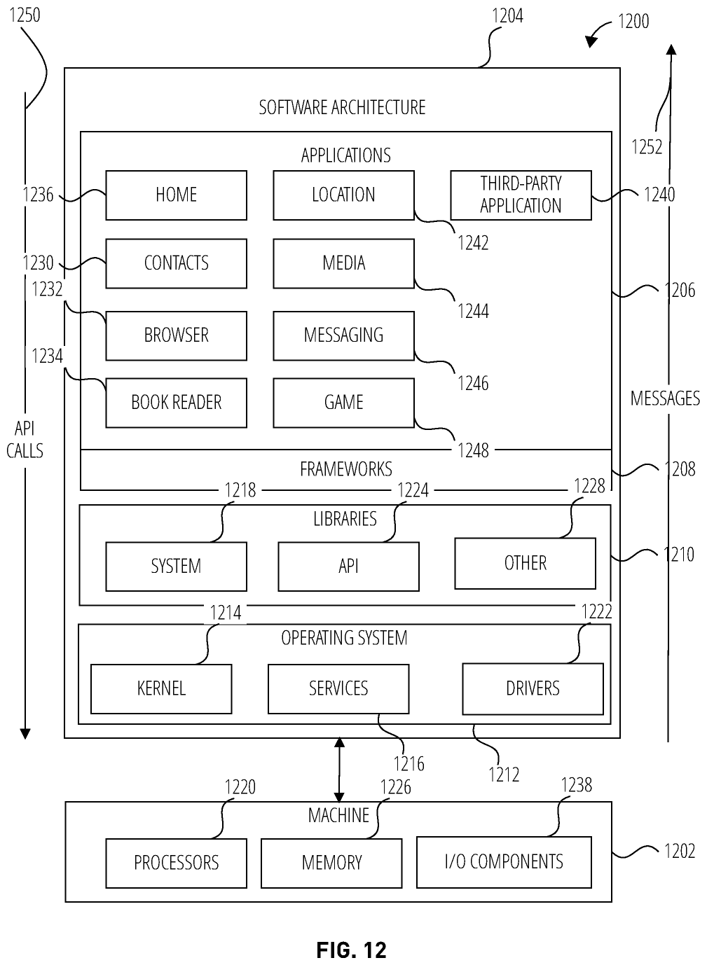

FIG. 12 is a block diagram 1200 illustrating a software architecture 1204, which can be installed on any one or more of the devices described herein. The software architecture 1204 is supported by hardware such as a machine 1202 that includes processors 1220, memory 1226, and I/O components 1238. In this example, the software architecture 1204 can be conceptualized as a stack of layers, where each layer provides a particular functionality. The software architecture 1204 includes layers such as an operating system 1212, libraries 1210, frameworks 1208, and applications 1206. Operationally, the applications 1206 invoke API calls 1250 through the software stack and receive messages 1252 in response to the API calls 1250.

The operating system 1212 manages hardware resources and provides common services. The operating system 1212 includes, for example, a kernel 1214, services 1216, and drivers 1222. The kernel 1214 acts as an abstraction layer between the hardware and the other software layers. For example, the kernel 1214 provides memory management, processor management (e.g., scheduling), component management, networking, and security settings, among other functionality. The services 1216 can provide other common services for the other software layers. The drivers 1222 are responsible for controlling or interfacing with the underlying hardware. For instance, the drivers 1222 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1210 provide a common low-level infrastructure used by the applications 1206. The libraries 1210 can include system libraries 1218 (e.g., C standard library) that provide functions such as memory allocation functions, string manipulation functions, mathematic functions, and the like. In addition, the libraries 1210 can include API libraries 1224 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1210 can also include a wide variety of other libraries 1228 to provide many other APIs to the applications 1206.

The frameworks 1208 provide a common high-level infrastructure that is used by the applications 1206. For example, the frameworks 1208 provide various graphical user interface (GUI) functions, high-level resource management, and high-level location services. The frameworks 1208 can provide a broad spectrum of other APIs that can be used by the applications 1206, some of which may be specific to a particular operating system or platform.

In an example, the applications 1206 may include a home application 1236, a contacts application 1230, a browser application 1232, a book reader application 1234, a location application 1242, a media application 1244, a messaging application 1246, a game application 1248, and a broad assortment of other applications such as a third-party application 1240. The applications 1206 are programs that execute functions defined in the programs. Various programming languages can be employed to create one or more of the applications 1206, structured in a variety of manners, such as object-oriented programming languages (e.g., Objective-C, Java, or C++) or procedural programming languages (e.g., C or assembly language). In a specific example, the third-party application 1240 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1240 can invoke the API calls 1250 provided by the operating system 1212 to facilitate functionality described herein.

Processing Components

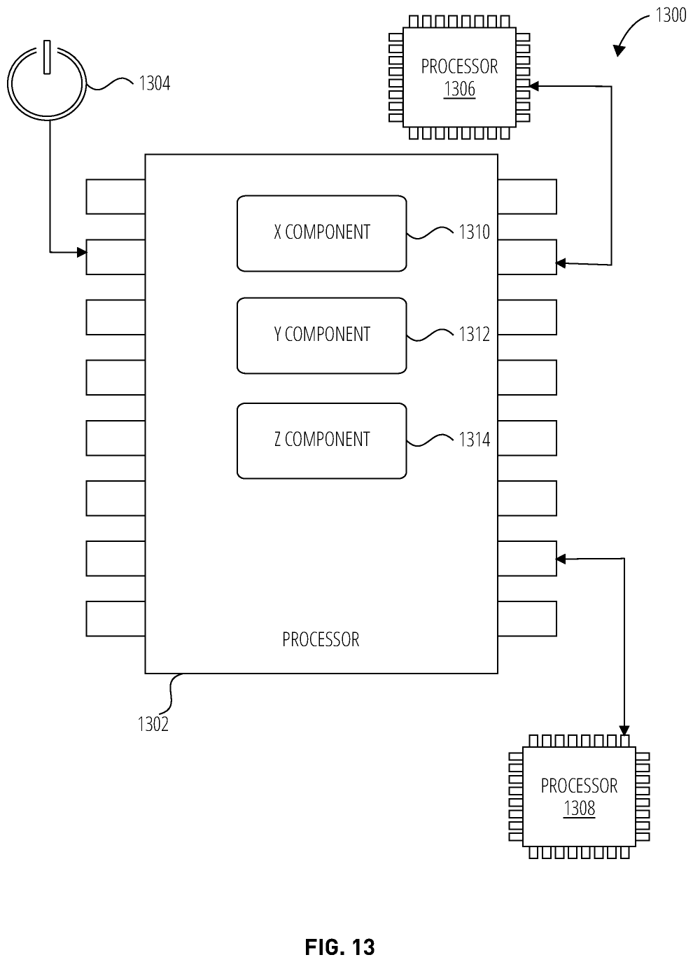

Turning now to FIG. 13, there is shown a diagrammatic representation of a processing environment 1300, which includes a processor 1302, a processor 1306, and a processor 1308 (e.g., a GPU, CPU or combination thereof).

The processor 1302 is shown to be coupled to a power source 1304, and to include (either permanently configured or temporarily instantiated) modules, namely an X component 1310, a Y component 1312, and a Z component 1314. The X component 1310 operationally generates previews of media items based on a media template and user profile data, the Y component 1312 operationally causes display of a presentation of a media collection, and the Z component 1314 operationally curates collections of media items. As illustrated, the processor 1302 is communicatively coupled to both the processor 1306 and the processor 1308.

### Glossary

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 1004 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method comprising:
presenting image data within a graphical user interface at a client device;
accessing a collection of media content at the client device, the media content including at least a first media content;
generating a preview of the first media content based on user profile data from a user profile associated with the client device; and
presenting the preview of the first media content within the image data at the client device.

2. The method of claim 1, wherein the user profile data includes an image.

3. The method of claim 1, wherein the generating the preview of the first media content includes:
presenting a request within the graphical user interface at the client device;
receiving a selection of the request;
activating a camera associated with the client device;
causing the camera to capture an image to be allocated to the user profile data of the user profile associated with the client device; and
generating the preview of the first media content based on the image.

4. The method of claim 1, wherein the method further comprises:
accessing the user profile associated with the client device;
identifying a user preference that includes an opt-in among the user profile data; and
generating the preview of the first media content based on the user profile data in response to the identifying the opt-in.

5. The method of claim 1, wherein the user profile is a first user profile that comprises first user profile data, and the presenting the image data within the graphical user interface includes:
receiving a request to generate a message from the client device, the request to generate the message including an identification of a second user profile;
accessing user profile data from the second user profile in response to the request to generate the message; and
generating the preview of the first media content based on the first user profile data and the second user profile data.

6. The method of claim 5, wherein the accessing the collection of media content at the client device further comprises:
selecting a subset of the collection of media content based on the first user profile data and the second user profile data, the subset of the collection of media content including the first media content.

7. The method of claim 5, wherein the generating the preview of the first media content based on the first user profile data and the second user profile data further comprises:
identifying an opt-in among the second user profile data of the second user profile; and
generating the preview of the first media content based on the first user profile data and the second user profile data in response to the identifying the opt-in among the second user profile data of the second user profile.

8. The method of claim 1, wherein the first media content includes a media template that comprises a set of graphical elements that include a customizable region, and wherein the generating the preview of the first media content includes:
applying the user profile data to the customizable region of the set of graphical elements.

9. The method of claim 1, wherein the accessing the collection of media content at the client device includes:
determining a contextual condition at the client device; and
accessing a subset of the collection of media content based on the contextual condition, the subset of the collection of media content including the first media content.

10. The method of claim 9, wherein the contextual condition includes one or more of temporal data and location data.

11. A system comprising:
a memory; and
at least one hardware processor coupled to the memory and comprising instructions that causes the system to perform operations comprising:
presenting image data within a graphical user interface at a client device;
accessing a collection of media content at the client device, the media content including at least a first media content;
generating a preview of the first media content based on user profile data from a user profile associated with the client device; and
presenting the preview of the first media content within the image data at the client device.

12. The system of claim 11, wherein the user profile data includes an image.

13. The system of claim 11, wherein the generating the preview of the first media content includes:
presenting a request within the graphical user interface at the client device;
receiving a selection of the request;
activating a camera associated with the client device;
causing the camera to capture an image to be allocated to the user profile data of the user profile associated with the client device; and
generating the preview of the first media content based on the image.

14. The system of claim 11, wherein the method further comprises:
accessing the user profile associated with the client device;
identifying a user preference that includes an opt-in among the user profile data; and
generating the preview of the first media content based on the user profile data in response to the identifying the opt-in.

15. The system of claim 11, wherein the user profile is a first user profile that comprises first user profile data, and the presenting the image data within the graphical user interface includes:
receiving a request to generate a message from the client device, the request to generate the message including an identification of a second user profile;
accessing user profile data from the second user profile in response to the request to generate the message; and
generating the preview of the first media content based on the first user profile data and the second user profile data.

16. The system of claim 15, wherein the accessing the collection of media content at the client device further comprises:
selecting a subset of the collection of media content based on the first user profile data and the second user profile data, the subset of the collection of media content including the first media content.

17. The system of claim 15, wherein the generating the preview of the first media content based on the first user profile data and the second user profile data further comprises:
identifying an opt-in among the second user profile data of the second user profile; and
generating the preview of the first media content based on the first user profile data and the second user profile data in response to the identifying the opt-in among the second user profile data of the second user profile.

18. The system of claim 11, wherein the first media content includes a media template that comprises a set of graphical elements that include a customizable region, and wherein the generating the preview of the first media content includes:
applying the user profile data to the customizable region of the set of graphical elements.

19. The system of claim 11, wherein the accessing the collection of media content at the client device includes:
determining a contextual condition at the client device; and
accessing a subset of the collection of media content based on the contextual condition, the subset of the collection of media content including the first media content.

20. A non-transitory machine-readable storage medium comprising instructions that, when executed by one or more processors of a machine, cause the machine to perform operations comprising:
presenting image data within a graphical user interface at a client device;
accessing a collection of media content at the client device, the media content including at least a first media content;
generating a preview of the first media content based on user profile data from a user profile associated with the client device; and
presenting the preview of the first media content within the image data at the client device.
